(19) United States
(12) Patent Application Publication
(10) Pub. No.: US 2017/0301435 A1
(43) Pub. Date: Oct. 19, 2017

(54) PROCESSING APPARATUS AND PROCESSING METHOD

(71) Applicant: Kabushiki Kaisha Toshiba, Minato-ku (JP)

(72) Inventors: Hideaki HIRABAYASHI, Yokohama (JP); Yuji NAGASHIMA, Kanagawa (JP)

(73) Assignee: Kabushiki Kaisha Toshiba, Minato-ku (JP)

(21) Appl. No.: 15/637,836

(22) Filed: Jun. 29, 2017

Related U.S. Application Data
(62) Division of application No. 14/927,887, filed on Oct. 30, 2015.

(30) Foreign Application Priority Data
Nov. 4, 2014 (JP) 2014-224480

(51) Int. Cl. H01B 19/04

(52) U.S. Cl. CPC H01B 19/04

(57) ABSTRACT

According to one embodiment, a processing apparatus includes a container, a processor, a supply unit, a recovery unit, a calculator, and a replenishing liquid supply unit. The container contains buffered hydrogen fluoride. The processor performs processing of a processing object using the buffered hydrogen fluoride. The supply unit supplies the buffered hydrogen fluoride to the processor. The buffered hydrogen fluoride is contained in the container. The recovery unit recovers the buffered hydrogen fluoride used in the processor and supplies the recovered buffered hydrogen fluoride to the container. The calculator calculates an evaporation amount of the buffered hydrogen fluoride. The replenishing liquid supply unit supplies the same amount of a replenishing liquid as the calculated evaporation amount of the buffered hydrogen fluoride to the buffered hydrogen fluoride. The replenishing liquid includes ammonia and water.

### CROSS-REFERENCE TO RELATED APPLICATIONS

This application is based upon and claims the benefit of priority from Japanese Patent Application No. 2014-224480, filed on Nov. 4, 2014; the entire contents of which are incorporated herein by reference.

### FIELD

Embodiments described herein relate generally to a processing apparatus and a processing method.

### BACKGROUND

Etching, cleaning, and the like that use buffered hydrogen fluoride (BHF) are performed to manufacture an electronic device such as a semiconductor device, a flat panel display, etc.

In the processing using buffered hydrogen fluoride, the processing rate (e.g., the etching rate of the etching, the removal rate of the cleaning, etc.) of the buffered hydrogen fluoride is set to be low to accommodate downscaling.

Also, in the processing using buffered hydrogen fluoride, the buffered hydrogen fluoride that has been used is recovered and re-utilized.

However, the processing rate undesirably increases gradually as the same buffered hydrogen fluoride is used repeatedly.

As the processing rate increases gradually, the removal amount of oxide films or the like increases gradually, which causes fluctuation of the quality of the electronic device.

Therefore, it is desirable to develop technology that can suppress the fluctuation of the processing rate even in the case where the buffered hydrogen fluoride is re-utilized.

### BRIEF DESCRIPTION OF THE DRAWINGS

FIG. 1 is a schematic view showing a processing apparatus 1 according to the embodiment;

FIG. 2 is a graph of relationships between the evaporation amount of the processing liquid 100 and the etching rate (the processing rate); and

FIG. 3 is a graph of relationships between the etching rate and the concentration of the ammonia of the replenishing liquid 110.

### DETAILED DESCRIPTION

In general, according to one embodiment, a processing apparatus includes a container, a processor, a supply unit, a recovery unit, a calculator, and a replenishing liquid supply unit. The container contains buffered hydrogen fluoride. The processor performs processing of a processing object using the buffered hydrogen fluoride. The supply unit supplies the buffered hydrogen fluoride to the processor. The buffered hydrogen fluoride is contained in the container. The recovery unit recovers the buffered hydrogen fluoride used in the processor and supplies the recovered buffered hydrogen fluoride to the container. The calculator calculates an evaporation amount of the buffered hydrogen fluoride. The replenishing liquid supply unit supplies the same amount of a replenishing liquid as the calculated evaporation amount of the buffered hydrogen fluoride to the buffered hydrogen fluoride. The replenishing liquid includes ammonia and water.

An embodiment will now be described with reference to the drawings.

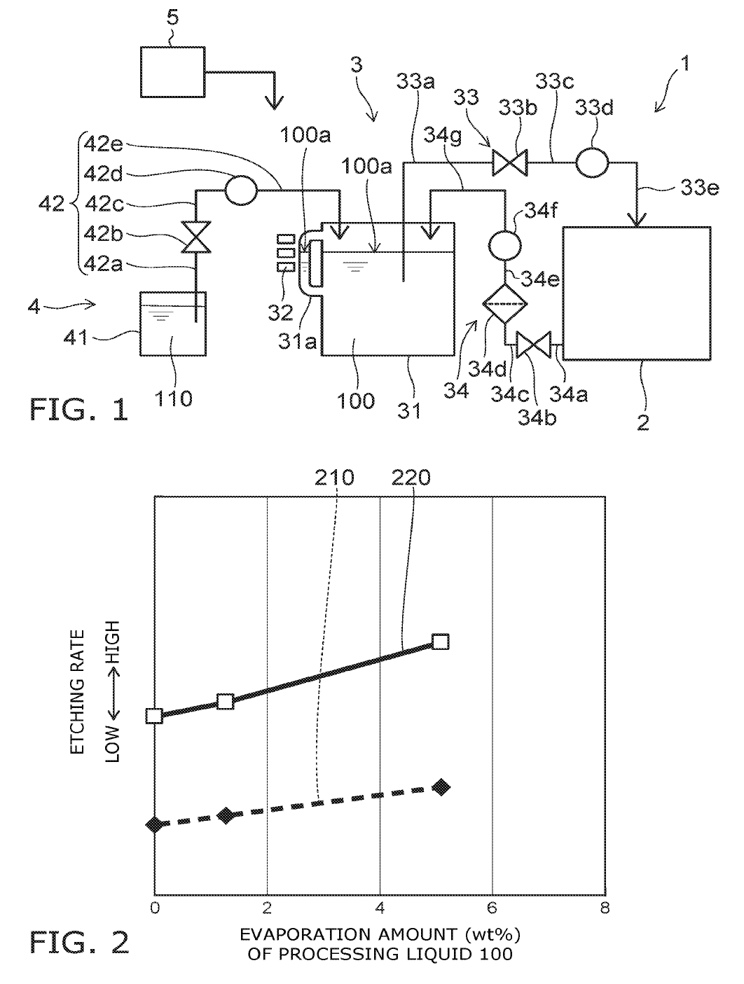

FIG. 1 is a schematic view showing a processing apparatus 1 according to the embodiment.

As shown in FIG. 1, a processor 2, a processing liquid supply/recovery unit 3, a replenishing liquid supply unit 4, and a controller 5 are provided in the processing apparatus 1.

The processor 2 performs processing of a processing object using buffered hydrogen fluoride (hereinbelow, called a processing liquid 100).

The processor 2 may be an etching apparatus, a cleaning apparatus, or the like that uses the processing liquid 100.

The processor 2 may be a single-wafer apparatus (e.g., an apparatus that supplies the processing liquid 100 to a rotating processing object), a batch apparatus (e.g., an apparatus that immerses multiple processing objects inside the processing liquid 100), an apparatus that supplies the processing liquid 100 to a processing object transferred by rollers, etc.

The processor 2 may include a known etching apparatus, cleaning apparatus, etc.; and a detailed description is therefore omitted.

The processing liquid supply/recovery unit 3 supplies the processing liquid 100 to the processor 2 and recovers the processing liquid 100 used in the processor 2.

A container 31, a sensor 32, a supply unit 33, and a recovery unit 34 are provided in the processing liquid supply/recovery unit 3.

The container 31 contains the processing liquid 100.

The sensor 32 senses the position of a liquid surface 100a of the processing liquid 100.

As described below, the evaporation amount of the processing liquid 100 can be determined directly by sensing the change of the position of the liquid surface 100a of the processing liquid 100.

The evaporation amount may be weight or volume.

The sensor 32 may be, for example, a photoelectric sensor including a light projector and a light receiver, etc.

A measurement unit 31a that is formed from a fluorocarbon resin or the like that is transparent is connected to the side wall of the container 31. The measurement unit 31a may be formed from a tubular body. The measurement unit 31a extends in the height direction of the container 31; and the upper end side and lower end side of the measurement unit 31a communicate with the interior of the container 31. The upper end of the measurement unit 31a is positioned higher than the liquid surface 100a. The lower end of the measurement unit 31a is positioned lower than the liquid surface 100a. Therefore, the position of the liquid surface 100a in the interior of the container 31 is the same as the position of the liquid surface 100a in the interior of the measurement unit 31a.

The sensor 32 may be multiply provided along the direction in which the measurement unit 31a extends. For example, the sensor 32 may be arranged at uniform spacing along the direction in which the measurement unit 31a extends. The refraction angle is different between the existence or absence of the processing liquid 100 because the refractive index of the processing liquid 100 is different from the refractive index of a gas such as air, etc. Therefore, the travel direction of the light emitted from the measurement unit 31a changes. When the travel direction of the light emitted from the measurement unit 31a changes, the amount of the light incident on the light receiver changes; and therefore, the position of the liquid surface 100a can be sensed from the output from the light receiver of each of the multiple sensors 32 provided along the direction in which the measurement unit 31a extends.

Although the measurement unit 31a is not always necessary, undulations or the like of the liquid surface 100a can be eliminated by providing the measurement unit 31a.

Although the case is shown where the position of the liquid surface 100a is directly sensed, the position of the liquid surface 100a also can be sensed indirectly by sensing a float, etc.

Although the case is shown where the sensor 32 is a photoelectric sensor, for example, the sensor 32 may be a proximity sensor, an ultrasonic sensor, etc.

The description recited above is the case where the evaporation amount of the processing liquid 100 is determined based on the change of the position of the liquid surface 100a of the processing liquid 100.

For example, the evaporation amount of the processing liquid 100 also can be determined directly based on the change of the weight of the processing liquid 100.

For example, the evaporation amount of the processing liquid 100 also can be determined indirectly based on the change of the viscosity of the processing liquid 100 or the change of the potential-hydrogen of the processing liquid 100.

Therefore, the sensor 32 can sense the position of the liquid surface 100a of the processing liquid 100, the weight of the processing liquid 100, the viscosity of the processing liquid 100, the potential-hydrogen of the processing liquid 100, etc.

For example, the weight of the processing liquid 100 can be determined by providing a weight meter, a load cell, etc., below the container 31 and subtracting the predetermined weight of the container 31 from the measured value.

The processing liquid 100 includes a component that evaporates easily and a component that does not evaporate easily.

Therefore, the composition ratio of the processing liquid 100 changes due to the evaporation of the processing liquid 100 because more of the component that evaporates easily evaporates when the processing liquid 100 evaporates.

For example, hydrofluoric acid, ammonia, and water are included in the processing liquid 100 which is buffered hydrogen fluoride. In such a case, the concentration of the hydrofluoric acid included in the processing liquid 100 increases when the processing liquid 100 evaporates because ammonia and water evaporate more easily than hydrofluoric acid.

The change of the composition ratio of the processing liquid 100 can be determined by measuring the viscosity, potential-hydrogen, or the like of the processing liquid 100. Because there is a correlation between the change of the composition ratio of the processing liquid 100 and the evaporation amount of the processing liquid 100, the evaporation amount of the processing liquid 100 can be determined indirectly from the viscosity, potential-hydrogen, or the like of the processing liquid 100.

For example, the viscosity of the processing liquid 100 can be measured by a known viscosimeter.

For example, the potential-hydrogen of the processing liquid 100 can be measured by a known pH sensor.

The viscosity or potential-hydrogen of the processing liquid 100 also can be measured in the interior of the container 31 or outside the container 31 (e.g., the supply unit 33, the recovery unit 34, etc.).

When manufacturing the electronic device, the environmental conditions such as the temperature, the pressure, etc., are controlled to be within prescribed ranges.

Therefore, there is a correlation between the processing time and the evaporation amount of the processing liquid 100.

Therefore, the evaporation amount of the processing liquid 100 also can be determined from the measured processing time, and from the relationship between the processing time and the evaporation amount of the processing liquid 100 that is predetermined by an experiment, a simulation, etc.

Thus, the sensor 32, the measurement unit 31a, etc., can be omitted.

The supply unit 33 supplies, to the processor 2, the processing liquid 100 contained in the container 31.

A pipe 33a, an open/close valve 33b, a pipe 33c, a pump 33d, and a pipe 33e are provided in the supply unit 33.

One end of the pipe 33a is provided inside the processing liquid 100 contained in the container 31.

The other end of the pipe 33a is connected to the open/close valve 33b.

The open/close valve 33b may be, for example, an air operated valve or the like that is resistant to the processing liquid 100.

One end of the pipe 33c is connected to the open/close valve 33b. The other end of the pipe 33c is connected to the pump 33d.

The pump 33d may be, for example, a chemical pump or the like that is resistant to the processing liquid 100.

One end of the pipe 33e is connected to the pump 33d. The other end of the pipe 33e is connected to the processor 2.

For example, the pipe 33a, the pipe 33c, and the pipe 33e may be formed from a fluorocarbon resin, etc.

Although the supply unit 33 is illustrated as including the pump 33d, the supply unit 33 is not limited thereto. For example, a component that supplies gas to the interior of the container 31 may be provided without providing the pump 33d. In such a case, the processing liquid 100 is supplied to the processor 2 by the processing liquid 100 that is contained in the interior of the container 31 being pressurized by the gas supplied to the interior of the container 31. The gas that is supplied to the interior of the container 31 may be, for example, an inert gas such as nitrogen gas, helium gas, or the like, air, a gas mixture including such gases, etc.

The recovery unit 34 recovers the processing liquid 100 used in the processor 2 and supplies the recovered processing liquid 100 to the container 31.

A pipe 34a, an open/close valve 34b, a pipe 34c, a filter 34d, a pipe 34e, a pump 34f, and a pipe 34g are provided in the recovery unit 34.

One end of the pipe 34a is connected to the processor 2. The other end of the pipe 34a is connected to the open/close valve 34b.

The open/close valve 34b may be, for example, an air operated valve or the like that is resistant to the processing liquid 100.

One end of the pipe 34c is connected to the open/close valve 34b. The other end of the pipe 34c is connected to the filter 34d.

For example, the filter 34d may trap the insoluble fluoride, etc., included in the used processing liquid 100. A filter that removes metal ions also may be provided.

One end of the pipe 34e is connected to the filter 34d. The other end of the pipe 34e is connected to the pump 34f.

The pump 34f may be, for example, a chemical pump or the like that is resistant to the processing liquid 100.

One end of the pipe 34g is connected to the pump 34f. The other end of the pipe 34g is connected to the container 31.

For example, the pipe 34a, the pipe 34c, the pipe 34e, and the pipe 34g may be formed from a fluorocarbon resin, etc.

As described above, the composition ratio of the processing liquid 100 changes when the processing liquid 100 evaporates. Therefore, the processing rate changes as the processing liquid 100 evaporates. For example, the ammonia and the water included in the processing liquid 100 which is buffered hydrogen fluoride evaporate more easily than the hydrofluoric acid included in the processing liquid 100. Therefore, when the processing liquid 100 evaporates, the processing rate increases because the concentration of the hydrofluoric acid included in the processing liquid 100 increases.

The replenishing liquid supply unit 4 suppresses the change of the processing rate by supplying a replenishing liquid 110 to the processing liquid 100 for which the processing rate has changed due to the evaporation.

In such a case, the replenishing liquid supply unit 4 supplies, to the processing liquid 100, the same amount of the replenishing liquid 110 as the evaporation amount of the processing liquid 100.

A container 41 and a supply unit 42 are provided in the replenishing liquid supply unit 4.

The container 41 contains the replenishing liquid 110.

The replenishing liquid 110 includes ammonia and water. As described below, the replenishing liquid 110 may be aqueous ammonia having a concentration of ammonia of not less than 2 wt % and not more than 4 wt %.

The details of the replenishing liquid 110 are described below.

The supply unit 42 supplies, to the container 31 of the processing liquid supply/recovery unit 3, the replenishing liquid 110 contained in the container 41.

A pipe 42a, an open/close valve 42b, a pipe 42c, a pump 42d, and a pipe 42e are provided in the supply unit 42.

One end of the pipe 42a is provided inside the replenishing liquid 110 contained in the container 41. The other end of the pipe 42a is connected to the open/close valve 42b.

The open/close valve 42b may be, for example, an air operated valve or the like that is resistant to the replenishing liquid 110.

One end of the pipe 42c is connected to the open/close valve 42b. The other end of the pipe 42c is connected to the pump 42d.

The pump 42d may be a variable delivery pump or the like that is resistant to the replenishing liquid 110.

The supply amount of the replenishing liquid 110 also can be controlled by providing a flow meter to measure the supply flow rate of the replenishing liquid 110 and by controlling the supply amount based on the output from the flow meter.

One end of the pipe 42e is connected to the pump 42d. The other end of the pipe 42e is connected to the container 31 of the processing liquid supply/recovery unit 3.

For example, the pipe 42a, the pipe 42c, and the pipe 42e are formed from a fluorocarbon resin, etc.

The controller 5 controls the operations of the components provided in the processing apparatus 1.

For example, the controller 5 controls the open/close valve 33b and the pump 33d to supply the processing liquid 100 to the processor 2 and to stop the supply.

For example, the controller 5 controls the open/close valve 34b and the pump 34f to recover the processing liquid 100 used in the processor 2 and supply the recovered processing liquid 100 to the container 31.

The controller 5 functions as a calculator that calculates the evaporation amount of the processing liquid 100.

For example, the controller 5 calculates the evaporation amount of the processing liquid 100 based on at least one selected from the group consisting of the position of the liquid surface 100a of the processing liquid 100 in the container 31, the weight of the processing liquid 100 in the container 31, the viscosity of the processing liquid 100, and the potential-hydrogen of the processing liquid 100.

The controller 5 also may calculate the evaporation amount of the processing liquid 100 from the processing time and the predetermined relationship between the processing time and the evaporation amount of the processing liquid 100.

For example, the controller 5 controls the open/close valve 42b and the pump 42d to supply, to the processing liquid 100 in the interior of the container 31, the same amount of the replenishing liquid 110 as the evaporation amount of the processing liquid 100 that is determined.

The replenishing liquid 110 will now be described further.

FIG. 2 is a graph of relationships between the evaporation amount of the processing liquid 100 and the etching rate (the processing rate).

In FIGS. 2, “210” illustrates the case of a thermal oxide film of silicon; and “220” illustrates the case of a TEOS (Tetra Ethyl Ortho Silicate) film.

Although the thermal oxide film 210 and the TEOS film 220 both are silicon oxide films, the etching rates are different because the film properties are different.

As described above, although hydrofluoric acid, ammonia, and water are included in the processing liquid 100 which is buffered hydrogen fluoride, the ammonia and the water evaporate more easily than the hydrofluoric acid. Therefore, the greater part of the processing liquid 100 that evaporates is ammonia and water.

The concentration of the hydrofluoric acid included in the processing liquid 100 increases when the ammonia and the water evaporate. Therefore, because the concentration of the hydrofluoric acid increases as the evaporation amount increases, the etching rate increases as can be seen from FIG. 2.

Here, in the case where the processing liquid supply/recovery unit 3 described above or the like is provided and the used processing liquid 100 is re-utilized, the same processing liquid 100 is used repeatedly. When the same processing liquid 100 is used repeatedly, the evaporation amount of the processing liquid 100 increases and the concentration of the hydrofluoric acid increases as the processing time elapses.

In such a case, the hydrofluoric acid is consumed as the processing proceeds; but the consumed hydrofluoric acid is slight compared to the evaporation amount of the ammonia and the water.

Therefore, the etching rate increases gradually as the processing time elapses. Such fluctuation of the etching rate causes the quality of the manufactured electronic device to fluctuate. Because the downscaling of electronic devices has progressed in recent years, there is a risk that the fluctuation of the etching rate may have a large effect on the quality of the electronic device.

Therefore, in the processing apparatus 1 according to the embodiment, the replenishing liquid supply unit 4 is provided; the replenishing liquid 110 is supplied to the processing liquid 100; and the evaporated ammonia and water are replenished.

In such a case, if the supply amount of the replenishing liquid 110 is greater than the evaporation amount of the processing liquid 100, the processing liquid 100 will have a hydrofluoric acid concentration that is lower than the hydrofluoric acid concentration of the unused processing liquid 100. If the supply amount of the replenishing liquid 110 is less than the evaporation amount of the processing liquid 100, the processing liquid 100 will have a hydrofluoric acid concentration that is higher than the hydrofluoric acid concentration of the unused processing liquid 100.

Therefore, the same amount of the replenishing liquid 110 as the evaporation amount of the processing liquid 100 is supplied to the processing liquid 100.

The concentration of the ammonia of the replenishing liquid 110 will now be described.

It is considered that the evaporation amount of the ammonia and the evaporation amount of the water have a substantially constant proportion when the processing liquid 100 evaporates.

According to knowledge obtained by the inventors, the fluctuation of the processing rate can be suppressed by supplying the same amount of the replenishing liquid 110 as the evaporation amount of the processing liquid 100 if the replenishing liquid 110 has a concentration of ammonia of not less than 2 wt % and not more than 4 wt %.

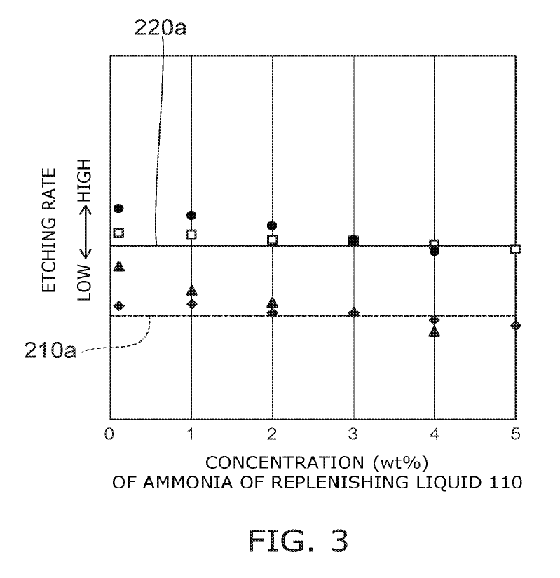

FIG. 3 is a graph of relationships between the etching rate and the concentration of the ammonia of the replenishing liquid 110.

In FIG. 3, “210a” is a line illustrating the etching rate when a thermal oxide film of silicon is etched using the unused processing liquid 100. In other words, “210a” is the line illustrating the value of the etching rate that is the target when suppressing the fluctuation of the etching rate by supplying the replenishing liquid 110.

“♦” (the diamonds) illustrates the etching rate for the thermal oxide film of silicon in the case where a 1.3 wt % processing liquid 100 evaporates and the same amount of the replenishing liquid 110 as the evaporation amount of the processing liquid 100 is supplied to the processing liquid 100.

“▴” (the triangles) illustrates the etching rate for the thermal oxide film of silicon in the case where a 5.1 wt % processing liquid 100 evaporates and the same amount of the replenishing liquid 110 as the evaporation amount of the processing liquid 100 is supplied to the processing liquid 100.

“220a” is a line illustrating the etching rate when a TEOS film is etched using the unused processing liquid 100. In other words, “220a” is the line illustrating the value of the etching rate that is the target when suppressing the fluctuation of the etching rate by supplying the replenishing liquid 110.

“□” (the squares) illustrates the etching rate for the TEOS film in the case where a 1.3 wt % processing liquid 100 evaporates and the same amount of the replenishing liquid 110 as the evaporation amount of the processing liquid 100 is supplied to the processing liquid 100.

“” (the circles) illustrates the etching rate for the TEOS film in the case where a 5.1 wt % processing liquid 100 evaporates and the same amount of the replenishing liquid 110 as the evaporation amount of the processing liquid 100 is supplied to the processing liquid 100.

It can be seen from FIG. 3 that the etching rate that is obtained can be substantially the same as the etching rate of the case where the unused processing liquid 100 is used if the replenishing liquid 110 has a concentration of ammonia of not less than 2 wt % and not more than 4 wt % and the same amount of the replenishing liquid 110 as the evaporation amount of the processing liquid 100 is supplied to the processing liquid 100.

In other words, it is sufficient for the replenishing liquid 110 to be aqueous ammonia having a concentration of ammonia of not less than 2 wt % and not more than 4 wt %.

Thus, because it is sufficient to supply the same amount of the replenishing liquid 110 as the evaporation amount of the processing liquid 100 for the replenishing liquid 110 having the prescribed ammonia concentration, the processing operation can be easier, the production efficiency can be increased, etc.

Effects of the processing apparatus 1 and the processing method according to the embodiment will now be described.

First, the processing object is transferred into the interior of the processor 2.

Then, the processing liquid 100 that is contained in the container 31 is supplied to the processor 2 by the supply unit 33 of the processing liquid supply/recovery unit 3.

The processor 2 performs the etching, cleaning, etc., of the processing object using the supplied processing liquid 100.

The processing object for which the processing has ended is dispatched from the processor 2; and the next processing object is transferred into the interior of the processor 2. Thereafter, multiple processing objects are sequentially processed similarly.

The processing liquid 100 that is used in the processor 2 is recovered by the recovery unit 34 and supplied to the container 31 after impurities are removed by the filter 34d.

Thereafter, the processing liquid 100 is used by circulating similarly.

Then, the evaporation amount of the processing liquid 100 is determined.

For example, the evaporation amount of the processing liquid 100 is determined from the difference between the amount of the processing liquid 100 before the processing operation start and the amount of the processing liquid 100 when using the processing liquid 100 by circulating.

In such a case, the amount of the processing liquid 100 when using the processing liquid 100 by circulating can be determined by sensing the position of the liquid surface 100a of the processing liquid 100, sensing the weight of the processing liquid 100, sensing the viscosity of the processing liquid 100, or sensing the potential-hydrogen of the processing liquid 100.

The evaporation amount of the processing liquid 100 also can be determined by measuring the processing time and by determining from a predetermined relationship between the processing time and the evaporation amount of the processing liquid 100.

Then, the same amount of the replenishing liquid 110 contained in the container 41 as the evaporation amount of the processing liquid 100 is supplied to the container 31 by the supply unit 42 of the replenishing liquid supply unit 4.

In other words, the same amount of the replenishing liquid 110 as the evaporation amount of the processing liquid 100 is supplied to the processing liquid 100, where the replenishing liquid 110 has a concentration of ammonia of not less than 2 wt % and not more than 4 wt %.

Thus, the fluctuation of the processing rate can be suppressed even in the case where the processing liquid 100 is re-utilized.

As described above, the processing method according to the embodiment may include:
a process of performing processing of the processing object using the processing liquid 100;
a process of recovering and re-utilizing the processing liquid 100 used in the process of performing processing of the processing object;
a process of determining the evaporation amount of the processing liquid 100; and
a process of supplying, to the re-utilized processing liquid 100, the same amount of the replenishing liquid 110 as the determined evaporation amount of the processing liquid 100, where the replenishing liquid 110 includes ammonia and water.

In such a case, the concentration of the ammonia of the replenishing liquid 110 may be set to be not less than 2 wt % and not more than 4 wt %.

In the process of determining the evaporation amount of the processing liquid 100, the evaporation amount of the processing liquid 100 can be determined from the processing time and a predetermined relationship between the processing time and the evaporation amount of the processing liquid 100.

In the process of determining the evaporation amount of the processing liquid 100, the evaporation amount of the processing liquid 100 can be determined based on at least one selected from the group consisting of the position of the liquid surface 100a of the re-utilized processing liquid 100, the weight of the re-utilized processing liquid 100, the viscosity of the re-utilized processing liquid 100, and the potential-hydrogen of the re-utilized processing liquid 100.

The contents of the processes may be similar to those described above, and a detailed description is therefore omitted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

1-15. (canceled)

16. A processing method, comprising:
performing processing of a processing object using buffered hydrogen fluoride;
recovering the buffered hydrogen fluoride used in the processing of the processing object and re-utilizing the recovered buffered hydrogen fluoride;
determining an evaporation amount of the recovered buffered hydrogen fluoride; and
supplying a replenishing liquid to the re-utilized buffered hydrogen fluoride based on the determined evaporation amount of buffered hydrogen fluoride, the replenishing liquid including at least ammonia and water.

17. The method according to claim 16, wherein a concentration of the ammonia of the replenishing liquid is not less than 2 wt % and not more than 4 wt %.

18. The method according to claim 16, wherein the determining of the evaporation amount of the buffered hydrogen fluoride includes determining the evaporation amount of the buffered hydrogen fluoride from a processing time and a relationship between the processing time and the evaporation amount of the buffered hydrogen fluoride, the relationship being predetermined.

19. The method according to claim 16, wherein the determining of the evaporation amount of the buffered hydrogen fluoride includes determining the evaporation amount of the buffered hydrogen fluoride based on at least one selected from the group consisting of a position of a liquid surface of the re-utilized buffered hydrogen fluoride, a weight of the re-utilized buffered hydrogen fluoride, a viscosity of the re-utilized buffered hydrogen fluoride, and a potential-hydrogen of the re-utilized buffered hydrogen fluoride.

20. The method according to claim 16, wherein the determining of the evaporation amount of the buffered hydrogen fluoride includes determining the evaporation amount of the buffered hydrogen fluoride from a difference between an amount of the buffered hydrogen fluoride before a processing operation start and an amount of the buffered hydrogen fluoride when the buffered hydrogen fluoride is recovered.
